(19) United States
(12) Patent Application Publication
(10) Pub. No.: US 2013/0076983 A1
(43) Pub. Date: Mar. 28, 2013

(54) TELEVISION SYSTEM AND METHOD OF WATCHING TELEVISION PROGRAMS

(71) Applicants: Yr. HONG, Xiamen (CN); Zi-Jie Huang, Xiamen (CN)

(72) Inventors: Yr. HONG, Xiamen (CN); Zi-Jie Huang, Xiamen (CN)

(73) Assignee: TPV Display Technology (Xiamen) Co., Ltd., XIamen Torch Hi-Tech Industrial Develop (CN)

(21) Appl. No.: 13/586,783

(22) Filed: Aug. 15, 2012

(30) Foreign Application Priority Data
Sep. 27, 2011 (TW) 100134764

(51) Int. Cl. H04N 5/45; H04N 5/50

(52) U.S. Cl. 348/565; 348/731; 348/E05.097; 348/E05.112

(57) ABSTRACT

A method of watching television programs, to be implemented using a television device and a remote control device that remotely controls the television device and that has an audio-video output module, includes: configuring first and second television tuners of the television device to receive the television program signals, respectively; and configuring the television device to receive an output television program command from the remote control device, and to select one of the television program signals for output to the remote control device and for subsequent reproduction by the audio-video output module of the remote control device.

### CROSS-REFERENCE TO RELATED APPLICATION

This application claims priority of Taiwanese Application No. 100134764, filed on Sep. 27, 2011.

### BACKGROUND OF THE INVENTION

1. Field of the Invention

The invention relates to a television system and a method of watching television programs to be implemented using a television device and a remote control device.

2. Description of the Related Art

There are currently a wide variety of television remote control devices having different functions. One conventional television remote control device has a display screen that enables users to view a digital television program guide and other information. Moreover, current television devices have a picture-in-picture playback function, i.e., the television screen displays a main image corresponding to one television program and a sub-image corresponding to another television program simultaneously. However, when two users watch two different television programs on the same screen in the picture-in-picture format, the two different television programs being reproduced may interfere with each other such that the two users may be unable to concentrate.

In addition, a television remote control device that has a display screen and that is able to reproduce the same television program being reproduced by the associated television device is known in the art. However, if the television device is operated in the picture-in-picture mode to reproduce two different television programs, the remote control device is only able to receive the main television program and not the other television program. In other words, the television program being reproduced by the remote control device is the main television program being reproduced by the television device in the picture-in-picture format. Therefore, even if the television device and the remote control device have two independent display screens, two users are notable to watch different television programs using the television device and the remote control device, respectively.

### SUMMARY OF THE INVENTION

Therefore, an object of the present invention is to provide a method of watching television programs to be implemented using a television device and a remote control device that is capable of remotely controlling the television device and that has an audio-video output module so that the same or different television programs may be reproduced using the television device and the remote control device.

According to one aspect of the present invention, a method of watching television programs is to be implemented using a television device and a remote control device that is capable of remotely controlling the television device and that has an audio-video output module. The method comprises the steps of:

(A) configuring first and second television tuners of the television device to receive first and second television program signals, respectively; and

(B) configuring the television device to receive an output television program command from the remote control device, and to select one of the first and second television program signals according to the output television program command for output to the remote control device and for subsequent reproduction by the audio-video output module of the remote control device.

Preferably, the method further comprises the step of configuring the television device to receive a picture-in-picture command from the remote control device and to reproduce the first and second television program signals in a picture-in-picture format according to the picture-in-picture command.

Preferably, in step (B), the television device is configured to reproduce the other one of the first and second television program signals in a single picture format when the selected one of the first and second television program signals is outputted to the remote control device.

Preferably, in step (B), the television device is configured to reproduce the first and second television program signals in a picture-in-picture format when the television device further receives a picture-in-picture command from the remote control device.

Another object of the present invention is to provide a television system for implementing the above method.

According to another aspect of the present invention, a television system comprises a television device and a remote control device.

The television device includes: first and second television tuners for receiving first and second television program signals, respectively; a first transmitting unit; a signal selecting unit coupled electrically to the first and second television tuners and the first transmitting unit, and operable to select one of the first and second television program signals from the first and second television tuners for transmission via the first transmitting unit; a first receiving unit for receiving a control command; a first control unit coupled electrically to the first receiving unit and the signal selecting unit, and controlling operation of the signal selecting unit according to the control command received by the first receiving unit; and a first audio-video output module for reproducing at least one of the first and second television program signals.

The remote control device includes: an input unit operable to provide an input; a second control unit coupled electrically to the input unit and operable to generate an output television program command according to the input from the input unit; a second transmitting unit coupled electrically to the second control unit for transmitting the output television program command to the first receiving unit, wherein the first control unit controls the signal selecting unit to output one of the first and second television program signals from the first and second television tuners for transmission via the first transmitting unit in accordance with the output television program command received by the first receiving unit; a second receiving unit for receiving the one of the first and second television program signals transmitted by the first transmitting unit; and a second audio-video output module for reproducing the one of the first and second television program signals received by the second receiving unit.

Preferably, the second control unit is further operable to generate a picture-in-picture command transmitted to the first receiving unit via the second transmitting unit according to the input from the input unit. The first control unit controls the first audio-video output module to reproduce the first and second television programs in a picture-in-picture format in accordance with the picture-in-picture command received by the first receiving unit from the remote control device.

Preferably, the first control unit controls the first audio-video output module to reproduce the other one of the first and second television program signals in a single picture format when the selected one of the first and second television program signals is transmitted via the first transmitting unit.

Preferably, the second control unit is further operable to generate a picture-in-picture command transmitted to the first receiving unit via the second transmitting unit according to the input from the input unit. The first control unit controls the first audio-video output module to reproduce the first and second television programs in a picture-in-picture format in accordance with the picture-in-picture command that is further received by the first receiving unit.

Preferably, each of the first and second audio-video output modules includes a display unit and a speaker unit.

Preferably, the first transmitting unit includes a universal serial bus (USB) wireless transmitter module coupled electrically to the signal selecting unit. The second receiving unit includes a USB wireless receiver module coupled electrically to the second control unit. The first transmitting unit and the second receiving unit are configured to communicate wirelessly with each other according to one of Bluetooth technology, Wi-Fi technology, and ultra-wideband technology.

According to this invention, the first control unit of the television device controls the signal selecting unit to output one of the first and second television program signals from the first and second television tuners in accordance with the output television program command from the remote control device. Therefore, users are able to watch the same or different television programs on the television device and the remote control device.

### BRIEF DESCRIPTION OF THE DRAWINGS

Other features and advantages of the present invention will become apparent in the following detailed description of the preferred embodiment with reference to the accompanying drawings, of which:

FIG. 1 is a block diagram illustrating a preferred embodiment of a television system of the present invention; and

FIG. 2 is a flowchart illustrating a preferred embodiment of a method of watching television programs to be implemented using the television system of FIG. 1.

### DETAILED DESCRIPTION OF THE PREFERRED EMBODIMENT

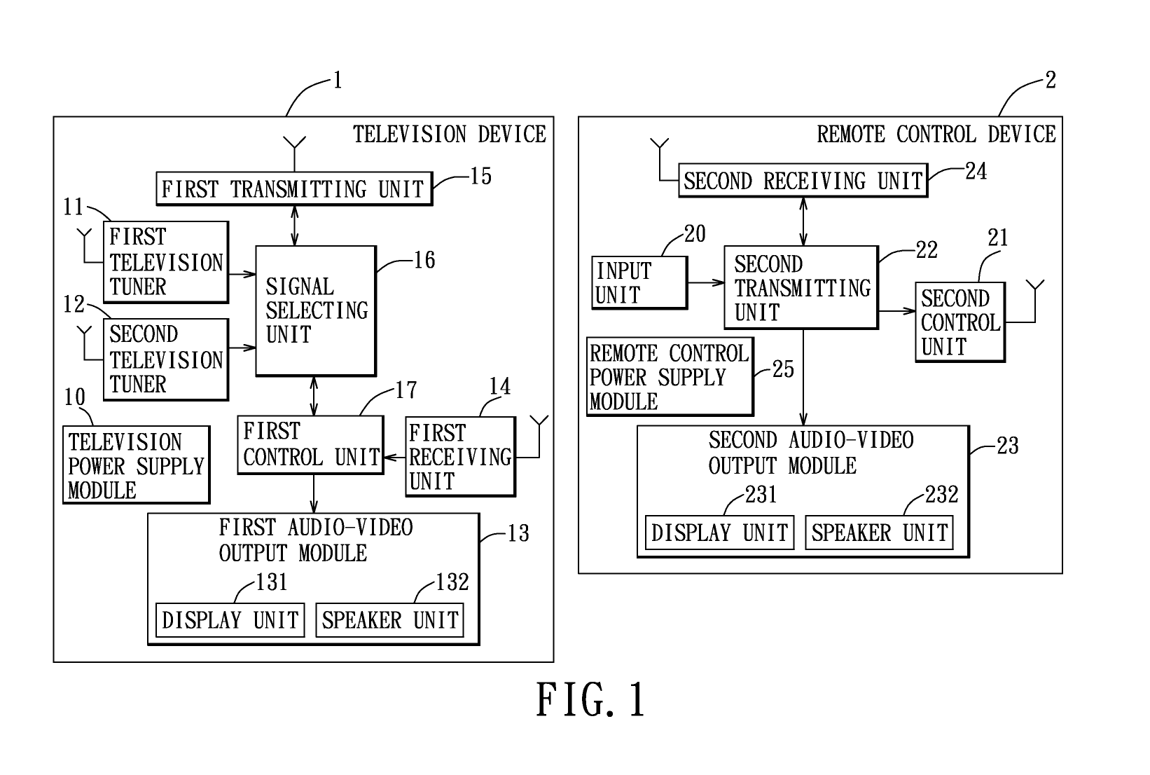

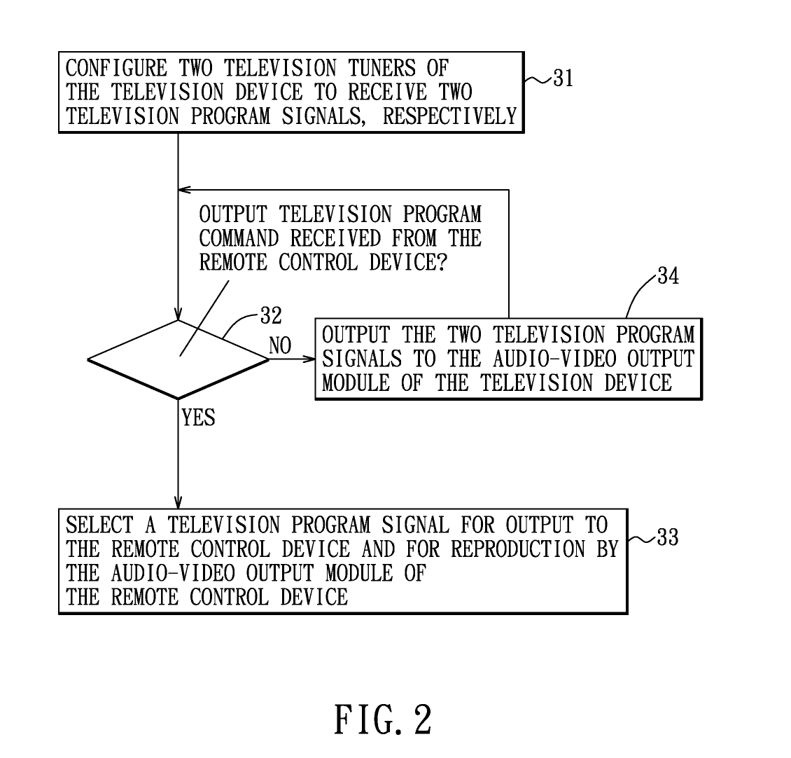

Referring to FIGS. 1 and 2, the preferred embodiment of a method of watching television programs according to the present invention is to be implemented using a television system that includes a television device 1 and a remote control device 2. The remote control device 2 can be an accessory of the television device 1 or other electronic devices capable of remotely controlling the television device 1, such as a smart phone.

In step 31 of the method of the preferred embodiment, first and second television tuners 11, 12 of the television device 1 are configured to receive first and second television program signals, respectively. The television device 1 further includes a television power supply module 10, a first audio-video output module 13, a first receiving unit 14, a first transmitting unit 15, a signal selecting unit 16, and a first control unit 17. The television power supply module 10 is operable to supply power to the first and second television tuners 11, 12, the first audio-video output module 13, the first receiving unit 14, the first transmitting unit 15, the signal selecting unit 16, and the first control unit 17. The first audio-video output module 13 is operable to reproduce at least one of the first and second television program signals. In this embodiment, the first audio-video output module 13 includes a display unit 131 (such as a liquid crystal display unit) and a speaker unit 132. The first receiving unit 14 is operable to receive a control command from the remote control device 2. The first transmitting unit 15 is operable to transmit television program signals. The signal selecting unit 16 is electrically coupled to the first and second television tuners 11, 12 and the first transmitting unit 15, and is operable to select one of the first and second television program signals from the first and second television tuners 11, 12 for transmission via the first transmitting unit 15. The first control unit 17 is coupled electrically to the first receiving unit 14 and the signal selecting unit 16, and controls the signal selecting unit 16 to select one of the first and second television program signals from the first and second television tuners 11, 12 according to the control command received by the first receiving unit 14.

The remote control device 2 includes an input unit 20, a second control unit 21, a second transmitting unit 22, a second audio-video output module 23, a second receiving unit 24, and a remote control power supply module 25. The remote control power supply module 25 is operable to supply power to the input unit 20, the second control unit 21, the second transmitting unit 22, the second audio-video output module 23, and the second receiving unit 24. The input unit 20 is operable to provide an input from a user for controlling operation of the television device 1. The second control unit 21 is coupled electrically to the input unit 20 and is operable to generate an output television program command according to the input from the input unit 20. The second transmitting unit 22 is coupled electrically to the second control unit 20 for transmitting the output television program command to the first receiving unit 14. Hence, the first control unit 17 controls the signal selecting unit 16 to output one of the first and second television program signals from the first and second television tuners 11, 12 for transmission via the first transmitting unit 15 in accordance with the output television program command received by the first receiving unit 14. The second receiving unit 24 is capable of receiving the one of the first and second television program signals transmitted by the first transmitting unit 15 of the television device 1. The second audio-video output module 23 is capable of reproducing the one of the first and second television program signals received by the second receiving unit 24. The second audio-video output module 23 includes a display unit 231 (such as a liquid crystal display unit) and a speaker unit 232 (or audio source output ports).

In this embodiment, the input unit 20 can be a physical keyboard or a touch keyboard. The input unit 20 is provided with a “picture-in-picture” press key (or a “picture-in-picture” option shown on the display unit 231). The input unit 20 is further provided with an “output television program” press key (or an “output television program” option shown on the display unit 231). When the “picture-in-picture” press key is pressed (or the “picture-in-picture” option is selected), the second control unit 21 is further operable to generate a picture-in-picture command transmitted to the first receiving unit 14 via the second transmitting unit 22. Similarly, when the “output television program” press key is pressed (or the “output television program” option is selected), the second control unit 21 is operable to generate an output television program command transmitted to the first receiving unit 14 via the second transmitting unit 22.

The first transmitting unit 15 can be a built-in wireless transmitter module in the television device 1 or a removable universal serial bus (USB) wireless transmitter module coupled electrically to the signal selecting unit 16 via a USB interface. The second receiving unit 24 can be a built-in wireless receiver module in the remote control device 2 or a removable USB wireless receiver module coupled electrically to the second control unit 21 via a USB interface. The first transmitting unit 15 and the second receiving unit 24 are configured to communicate wirelessly with each other according to one of Bluetooth technology, Wi-Fi technology, and ultra-wideband technology. While the first receiving unit 14 and the second transmitting unit 22 are configured to communicate with each other using infrared technology in this embodiment, the invention should not be limited in this respect.

In step 32 of the method of the preferred embodiment, the television device 1 determines whether an output television program command is received from the remote control device 2. If affirmative, the flow goes to step 33. Otherwise, the flow goes to the step 34. In step 33, the television device 1 is operable to select one of the first and second television program signals according to the output television program command for output to the remote control device 2 and for subsequent reproduction by the audio-video output module 23 of the remote control device 2. In detail, when the first receiving unit 14 of the television device 1 receives an output television program command from the second transmitting unit 22 of the remote control device 2, the first control unit 17 controls the signal selecting unit 16 to select one of the first and second television program signals from the first and second television tuners 11, 12 according to the output television program command for transmission to the second receiving unit 24 of the remote control device 2 via the first transmitting unit 15. In this embodiment, the picture-in-picture press key may be pressed (or the picture-in-picture option may be selected) before the “output television program” press key is pressed (or the “output television program” option is selected) at the remote control device 2. In response, the second control unit 21 is operable to generate a picture-in-picture command transmitted to the first receiving unit 14 of the television device 1 via the second transmitting unit 22. When the first receiving unit 14 receives the picture-in-picture command, the first control unit 17 provides the first and second television program signals received from the signal selecting unit 16 to the first audio-video output module 13. The first audio-video output module 13 is then controlled by the first control unit 17 to reproduce the first and second television program signals in the picture-in-picture format, wherein the first television program signal from the first television tuner 11 is reproduced as amain television program, and the second television program signal from the second television tuner 12 is reproduced as a sub-television program.

In this embodiment, the user can use the remote control device 2 to select one of the first and second television program signals. Thereafter, when the “output television program” press key is pressed (or the “output television program” option is selected) at the remote control device 2, the second control unit 21 generates an output television program command which indicates the program signal selected by the user. The second transmitting unit 22 of the remote control device 2 transmits the output television program command to the first receiving unit 14 of the television device 1. When the first receiving unit 14 receives the output television program command, the first control unit 17 controls the signal selecting unit 16 to output the selected television program signal for transmission via the first transmitting unit 15 in accordance with the output television program command. For example, if the output television program command indicates the second television program signal, the first control unit 17 controls the signal selecting unit 16 to output the second television program signal from the second television tuner 12 for transmission via the first transmitting unit 15. On the other hand, if the output television program command indicates the first television program signal, the first control unit 17 controls the signal selecting unit 16 to output the first television program signal from the first television tuner 11 for transmission via the first transmitting unit 15. Therefore, the user can use the remote control device 2 to select the television program signal to be reproduced by the second audio-video output module 23. Two individual users are thus able to watch two different television programs on the television device 1 and the remote control device 2.

When the user completes the above operation for causing the remote control device 2 to generate and transmit the output television program command, the television device 1 may be configured to reproduce the other one of the first and second television program signals in a single picture format automatically. Alternatively, the user can perform manual control to terminate the picture-in-picture function. As an example, the “picture-in-picture” press key may be pressed again (or the “picture-in-picture” option may be selected again) to switch to reproduction of the other one of the first and second television program signals in a single picture format. By configuring the television device 1 for reproduction in the single picture format, the user may be prevented from being disturbed when watching the television program signal reproduced by the television device 1. The television device 1 may resume reproduction of the first and second television program signals in the picture-in-picture format when the television device 1 receives the picture-in-picture output television program command from the remote control device 2 once more.

In this embodiment, when the television device 1 determines in step 32 that the output television program command is not received from the remote control device 2, the flow goes to step 34. In step 34, the first control unit 17 controls the signal selecting unit 16 to output the first and second television program signals from the first and second television tuners 11, 12 to the first audio-video output module 13. In this embodiment, the first audio-video output module 13 is configured to reproduce one of the first and second television signals. When the television device 1 subsequently receives the picture-in-picture output television program command from the remote control device 2, the first audio-video output module 13 is configured to reproduce the first and second television program signals in the picture-in-picture format. Therefore, when the picture-in-picture function is not selected, the television device 1 may be configured to disable one of the first and second television tuners 11, 12 to reduce power consumption.

To sum up, the first control unit 17 of the television device 1 controls the signal selecting unit 16 to output one of the first and second television program signals from the first and second television tuners 11, 12 in accordance with the output television program command from the remote control device 2. Therefore, users are able to watch the same or different television programs on the television device 1 and the remote control device 2.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method of watching television programs to be implemented using a television device and a remote control device that is capable of remotely controlling the television device and that has an audio-video output module, said method comprising the steps of:
(A) configuring first and second television tuners of the television device to receive first and second television program signals, respectively; and
(B) configuring the television device to receive an output television program command from the remote control device, and to select one of the first and second television program signals according to the output television program command for output to the remote control device and for subsequent reproduction by the audio-video output module of the remote control device.

2. The method of claim 1, further comprising the step of:
configuring the television device to receive a picture-in-picture command from the remote control device and to reproduce the first and second television program signals in a picture-in-picture format according to the picture-in-picture command.

3. The method of claim 1, wherein, in step (B), the television device is configured to reproduce the other one of the first and second television program signals in a single picture format when the selected one of the first and second television program signals is outputted to the remote control device.

4. The method of claim 1, wherein, in step (B), the television device is configured to reproduce the first and second television program signals in a picture-in-picture format when the television device further receives a picture-in-picture command from the remote control device.

5. A television system comprising:
a television device including
first and second television tuners for receiving first and second television program signals, respectively,
a first transmitting unit,
a signal selecting unit coupled electrically to said first and second television tuners and said first transmitting unit, and operable to select one of the first and second television program signals from said first and second television tuners for transmission via said first transmitting unit,
a first receiving unit for receiving a control command,
a first control unit coupled electrically to said first receiving unit and said signal selecting unit, and controlling operation of said signal selecting unit according to the control command received by said first receiving unit, and
a first audio-video output module for reproducing at least one of the first and second television programs signals; and
a remote control device including
an input unit operable to provide an input,
a second control unit coupled electrically to said input unit and operable to generate an output television program command according to the input from said input unit,
a second transmitting unit coupled electrically to said second control unit for transmitting the output television program command to said first receiving unit, wherein said first control unit controls said signal selecting unit to output one of the first and second television program signals from said first and second television tuners for transmission via said first transmitting unit in accordance with the output television program command received by said first receiving unit,
a second receiving unit for receiving said one of the first and second television program signals transmitted by said first transmitting unit, and
a second audio-video output module for reproducing said one of the first and second television program signals received by said second receiving unit.

6. The television system of claim 5, wherein:
said second control unit is further operable to generate a picture-in-picture command transmitted to said first receiving unit via said second transmitting unit according to the input from said input unit, and
said first control unit controls said first audio-video output module to reproduce the first and second television programs in a picture-in-picture format in accordance with the picture-in-picture command received by said first receiving unit.

7. The television system of claim 5, wherein said first control unit controls said first audio-video output module to reproduce the other one of the first and second television program signals in a single picture format when the selected one of the first and second television program signals is transmitted via said first transmitting unit.

8. The television system of claim 5, wherein:
said second control unit is further operable to generate a picture-in-picture command transmitted to said first receiving unit via said second transmitting unit according to the input from said input unit, and
said first control unit controls said first audio-video output module to reproduce the first and second television programs in a picture-in-picture format in accordance with the picture-in-picture command that is further received by said first receiving unit.

9. The television system as claimed in claim 5, wherein each of said first and second audio-video output modules includes a display unit and a speaker unit.

10. The television system as claimed in claim 5, wherein said first transmitting unit includes a universal serial bus (USB) wireless transmitter module coupled electrically to said signal selecting unit, and said second receiving unit includes a USB wireless receiver module coupled electrically to said second control unit.

11. The television system as claimed in claim 5, wherein said first transmitting unit and said second receiving unit are configured to communicate wirelessly with each other according to one of Bluetooth technology, Wi-Fi technology, and ultra-wideband technology.
